(19) United States
(12) Patent Application Publication
(10) Pub. No.: US 2018/0050305 A1
(43) Pub. Date: Feb. 22, 2018

(54) METHOD AND APPARATUS FOR FUMIGANT GAS CAPTURE

(71) Applicant: GENERA LIMITED, Tauranga (NZ)

(72) Inventor: Nicholas Mark SELF, Rotorua (NZ)

(21) Appl. No.: 15/553,245

(22) PCT Filed: Feb. 18, 2016
(86) PCT No.: PCT/NZ2016/050019

§ 371 Date: Aug. 24, 2017

(30) Foreign Application Priority Data
Feb. 25, 2015 (NZ) 705400

(51) Int. Cl. B01D 53/78

(52) U.S. Cl. CPC B01D 53/78

(57) ABSTRACT

In one aspect the invention provides a fumigant gas capture apparatus. This apparatus includes at least one channel adapted for connection to a volume containing a fumigant gas, the channel defining an inlet which receives gas and an outlet which allows gas to exit the channel. The apparatus also includes at least one drive structure arranged to drive fumigant gas through the channel, at least one spray nozzle adapted to deliver a treatment liquid into the channel, and at least one packing element positioned within the channel to allow a spray nozzle or nozzle to spray treatment liquid on to the packing element.

### FIELD OF THE INVENTION

This invention relates to a method and apparatus for fumigant gas capture. In preferred embodiments the invention can be used to treat or neutralise fumigant compounds.

### BACKGROUND OF THE INVENTION

Fumigant gases are used to kill unwanted organisms in a variety of applications. For example, fumigant gases which act as pesticides herbicides or insecticides can be circulated within an enclosed volume. Fumigant gases can be used to kill pests in the interior of structures such as buildings, ship holds or grain silos, as well as to sterilise goods present within shipping containers. In other applications fumigant gases can be deployed into stacks of logs wrapped in fabric covers to sterilise the wood prior to or after shipping. The range of applications for fumigant gases requires these gases to be pumped into and removed from both comparatively small and relatively large enclosed volumes.

However a number of commonly used fumigation gas compounds pose human health and safety risks. Furthermore, some of these compounds are also a source of environmental pollution when vented directly to the atmosphere. For example, methyl bromide is a widely used fumigant which reacts with ozone. Various regulatory bodies around the world are now beginning to restrict the venting of these types of gases directly to the atmosphere.

A number of prior art technologies have been developed to capture, scrub or process fumigant gases released into various enclosed environments.

For example, US patent application US2010/0172807 discloses a representative example of a fumigation gas scrubber which bubbles fumigant gas through a bath of reactive liquid. These bath based systems rely on sufficient contact surface area of fumigate gas exposed to the treatment solution to react the gas into a less problematic compound. Due to gas bubble sizes these systems are only practical or effective when used to treat small volumes or low flow rates of fumigant gas. As the gas flow rate applied to the solution bath increases so does the volume of the gas bubbles transiting the bath which limits the amount of fumigant gas exposed to and treated by the bath solution.

One attempt to address the scale or usability issues present in the above systems has been to initially capture the fumigant gas in a matrix of activated carbon. U.S. Pat. No. 5,904,909 provides a representative example of this form of technology. Gas flows containing fumigant gases are delivered to a conduit containing arrays of activated carbon material which capture and remove the fumigant gas compounds from the gas flow. The activated carbon in these conduits will eventually become saturated with is these compounds. The carbon is then removed and exposed to a further solvents or reactive solutions used to treat and neutralise the trapped fumigant gas compounds.

These types of activated carbon gas scrubbers can function effectively to capture and treat large volumes of fumigant gas delivered at comparatively high flow rates. However they are material intensive systems to implement and have high maintenance requirements. Furthermore the capture of some types of fumigant gases by the activated carbon triggers an exothermic reaction, which requires the heat generated to be carefully managed and which poses a potential fire risk.

It would therefore be of advantage to have improvements over the prior art which addressed the above problems or at least provided the public with an alternative choice. An improved fumigation gas capture and treatment technology which could be used practically with both small and large volumes of fumigant gases and which was inexpensive to implement, run and maintain would be of particular advantage. An improved fumigation gas capture and treatment apparatus which could be transported from site to site easily and which could be configured to fit within restricted spaces would also be of advantage.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### DISCLOSURE OF THE INVENTION

According to one aspect of the present invention there is provided a fumigant gas capture apparatus which includes

at least one channel adapted for connection to a volume containing a fumigant gas, the channel defining an inlet which receives gas and an outlet which allows gas to exit the channel,

at least one drive structure arranged to drive fumigant gas through the channel,

at least one spray nozzle adapted to deliver a treatment liquid into the channel, and

at least one packing element positioned within the channel to allow a spray nozzle or nozzle to spray treatment liquid on to the packing element.

According to a further aspect of the present invention there is provided a fumigant gas capture apparatus substantially as described above which includes a reservoir of treatment liquid adapted to deliver treatment liquid to said at least one spray nozzle.

A method of fumigant gas capture characterised by the steps of:
spraying a treatment liquid into a channel to intersect with at least one packing element, and
driving a fumigant gas through the channel and into contact with the sprayed treatment liquid.

According to a further aspect of the present invention there is provided a fumigant gas capture apparatus substantially as described above wherein spraying treatment liquid on a packing element reduces the size of treatment liquid droplets which the fumigant gases are exposed to when driven through the channel. A packing element used with the invention also increases turbulence of the air flow through the column, increasing the interaction between fumigant gases and treatment liquid.

According to a further aspect of the present invention there is provided a fumigant gas capture apparatus substantially as described above wherein said at least one packing element is sprayed with treatment liquid by a spray nozzle to coat at least a portion of the surface of the packing element with treatment liquid to expose fumigant gases to the coated surface or surfaces of the packing element when driven through the channel.

Preferably the treatment liquid is a basic or alkaline liquid having a pH value of at least seven.

Preferably the treatment liquid is composed from or includes an organic is solvent.

According to a further aspect of the present invention there is provided a fumigant gas capture apparatus substantially as described above wherein at least one spray nozzle is located adjacent to the outlet of a channel.

Preferably a channel is provided with a substantially vertical orientation with the outlet at the top of the channel and the inlet at the bottom of the channel. In this arrangement a channel forms a substantially vertical hollow column through which gas is forced upwards against a flow of the treatment liquid.

According to a further aspect of the present invention there is provided a fumigant gas capture apparatus substantially as described above which includes a plurality of channels with the outlet of at least one channel being connected to the inlet of a further channel.

According to another aspect of the present invention there is provided a fumigant gas capture apparatus substantially as described above which includes a heat transfer structure engaged with the inlet of at least one channel.

The present invention is adapted to provide an apparatus and method for the capture of fumigant gases. The invention employs the use of a treatment liquid to capture and react with these fumigant gases delivered from a volume being fumigated (referred to herein as ‘the fumigation chamber’).

Those skilled in the art will appreciate that this invention may be used to capture and treat a range of fumigant gases which can be delivered from a variety of environments. The present invention may—for example—be used to capture and treat fumigant gases formed from methyl bromide, sulphuryl fluoride, or phosphine in various applications. Furthermore the invention may be used, for example, to receive fumigant gases extracted from within the interior of buildings, grain silos, ship holds, shipping containers or fumigant gases trapped under covered stacks of logs in various applications.

Reference in general throughout this specification will however be made primarily to the invention being used to capture and treat methyl bromide as a fumigant gas. Again those skilled in the art will appreciate that other types of gas may also be captured and treated in conjunction with the present invention.

The invention employs at least one channel to control the passage or motion of the fumigant gas being treated. A channel used in conjunction with the present invention may preferably be formed by any type of conduit, housing or enclosure which defines a pathway from an inlet to an outlet. Preferably the path defined by the channel may be substantially linear, although those skilled in the art will appreciate that alternative shapes or forms of conduit may also be employed in a variety of embodiments.

In a preferred embodiment a channel employed with the invention may form or define a single inlet at one end and a single outlet at its opposite end. Again however in other embodiments multiple outlets and/or multiple inlets may be provided for a single channel.

In a preferred embodiment a channel may be provided with a substantially vertical orientation which positions its outlet at the top of the channel and its inlet at the bottom of the channel. Again however those skilled in the art will appreciate that other channel orientations—be they horizontal or angled—may also be employed in various embodiments.

In a preferred embodiment a capture apparatus provided by the invention may incorporate a plurality of channels. Potentially each of these channels may provide a conduit for a separate or independent fumigant gas flow. However in a further preferred embodiment these channels may be arranged for interconnection with one another with linkages being provided between the outlet of one or more channels to the inlet of one or more further channels. In such embodiments fumigant gas flows may be filtered through a number of sequentially arrayed channels, potentially being returned again to the first channel in the sequence to recirculate these gas flows if required. This arrangement of the invention provides it with a high degree of flexibility and variability in how gas flows are managed and treated. In some cases a single channel only may be employed to treat a gas flow, while in other applications a gas flow may be run through a sequential array of channels depending on the volume of gas to be treated and the concentration of fumigant gas compounds it contains.

In a preferred embodiment the present invention also includes a mobile support platform. This platform may be used to mount and support the various components of the invention and in particular preferred embodiments may support a plurality of channels. In a further preferred embodiment a mobile support platform may be supported by set of wheels and preferably include a towing linkage to allow the apparatus to be towed by a vehicle to a new location.

In these embodiments the vertical height of each of the invention's channels may be restricted or controlled to provide a compact and maneuverable mobile apparatus. A number of interconnected channels may be mounted on this type of mobile platform to provide the processing capacity required in a range of applications—without necessarily increasing the height of the apparatus to an extent which would prevent it from accessing confined locations.

The invention includes at least one drive structure formed from a fan or pump arranged to drive gas flows through its channel or channels. Those skilled in the art will appreciate that various arrangements and configurations of such a drive structure or structures may be employed in a range of embodiments. For example, in some instances the invention may employ a pair of fans or pumps to both push and or pull gas flows through conduits, whereas in other cases a fan or pump may be provided for each and every channel integrated into the apparatus.

Preferably the invention incorporates at least one spray nozzle for every channel it integrates. A spray nozzle is provided to deliver treatment liquid into the interior of a channel, preferably in the form of a mist of small droplets.

In some embodiments the treatment apparatus integrates one spray nozzle only in each of its channels. A single nozzle can be arranged or positioned adjacent to the outlet of the channel in such embodiments.

However those skilled in the art will appreciate that other configurations and arrangements of the invention are also within its scope. For example, in other embodiments two or potentially more spray nozzles may be located within a channel, be they at the outlet or adjacent to the outlet of the channel, or deployed along the length of the channel.

The invention incorporates at least one packing element located within a channel between the inlet and outlet of the channel. A packing element used with the invention is exposed to the spray of treatment liquid provided by a nozzle and promotes or assists in changing the phase of the fumigant gas compounds into a liquid form.

Preferably a packing element used with the invention acts to reduce the size of treatment liquid droplets which impact with the element. Relatively large drops of liquid sprayed on to a packing element are broken up and atomised further to preferably create a fine mist of treatment liquid within the channel.

Preferably a packing element used with the invention increases the contact surface area of sprayed treatment liquid to the gas driven through a channel. Treatment liquid sprayed on to a packing elements coats a surface (and preferably all surfaces) of the element thereby increasing the surface area contact between fumigant gas and treatment liquid.

Preferentially the packing material increases turbulence within the fumigant gas flow to provide greater interaction with the sprayed treatment liquid to increase the rate of transfer of fumigant molecules from the gas to liquid phase.

In a further preferred embodiment a packing element may be formed from a tellerette with an appropriate shape and dimensions arranged to optimise the surface area contact between the gases and liquids within a channel.

In a preferred embodiment a channel employed with the invention may be used to locate a large number of packing elements. These packing elements can form a packed tower arrangement when a channel has a substantially vertical orientation, substantially increasing the contact surface area between treatment liquid sprayed into the top of the tower and fumigant gases driven through the bottom of the tower.

The present invention may employ a range of different types of treatment liquids depending on the fumigant gas it is used to capture and treat. In a variety of embodiments the treatment liquid used is preferably a basic or alkali solution with a pH value of at least seven.

In a preferred embodiment the treatment liquid employed by the invention may be composed from or include an organic solvent. These compounds perform efficiently in respect of both the capture of fumigant gas compounds into a liquid form, in addition to reacting with the chemicals of the fumigant to neutralise same. An organic solvent provides specific advantages to the invention in terms of speed of operation and the volumes of fumigant gas which can be treated in a reasonable length of time. As these compounds readily captures fumigant gases and can then subsequently neutralise them in one step large volumes of fumigants can be processed efficiently by the invention.

In a preferred embodiment the invention may include a heat transfer structure engaged with the inlet of at least one channel. A heat transfer element can be used to increase the temperature of gas flowing entering the inlet of a channel, potentially increasing the efficiency of the apparatus provided.

In a further preferred embodiment a heat transfer structure may be formed from a heat exchange coil which surrounds a section of conduit linked to a channel inlet and transporting a flow of fumigant gas. Such a structure can also incorporate a heat source—such as, for example, a hydrocarbon burner—which is used to heat a warm a fluid circulated through the heat exchange coil. For example, in one possible embodiment a diesel burner system may be used to heat water which is circulated through the heat exchange coil to pre-heat fumigant gas flows entering a channel inlet.

Those skilled in the art will appreciate that the invention may include a is single heat transfer structure linked to one or more channels, or a plurality of heat exchange structures—with the potential for one being provided for each channel of the invention.

The present invention provides many potential advantages over the prior art.

In various embodiments the invention can be used to both capture and treat fumigant gases supplied over a range of flow rates from a variety of fumigated enclosures. The invention utilises a spray of treatment liquid to capture and treat fumigant gases, with this liquid only needing to be drained from the apparatus after the completion of one or more treatment cycles. This may be contrasted with prior art activated carbon-based based gas scrubbing systems which have significantly increased implementation and maintenance requirements.

In embodiments where a plurality of channels are provided these channels can be interconnected with one another in a modular fashion to suit the requirements of a particular application or fumigation space. Furthermore in some embodiments this staged or modular arrangement provides for a portable character allowing the operative components of the invention to be mounted to a mobile platform capable of being towed from site to site.

### BRIEF DESCRIPTION OF THE DRAWINGS

Additional and further aspects of the present invention will be apparent to the reader from the following description of embodiments, given in by way of example only, with reference to the accompanying drawings in which:

FIG. 1 shows a side view of a fumigant is gas capture and treatment apparatus as provided in accordance with a preferred embodiment, and:

FIG. 2 shows a plan view of the apparatus of FIG. 1, and

FIG. 3 shows a side cross-section view of one of the channels integrated into the apparatus shown with respect to FIGS. 1 and 2.

Further aspects of the invention will become apparent from the following description of the invention which is given by way of example only of particular embodiments.

### BEST MODES FOR CARRYING OUT THE INVENTION

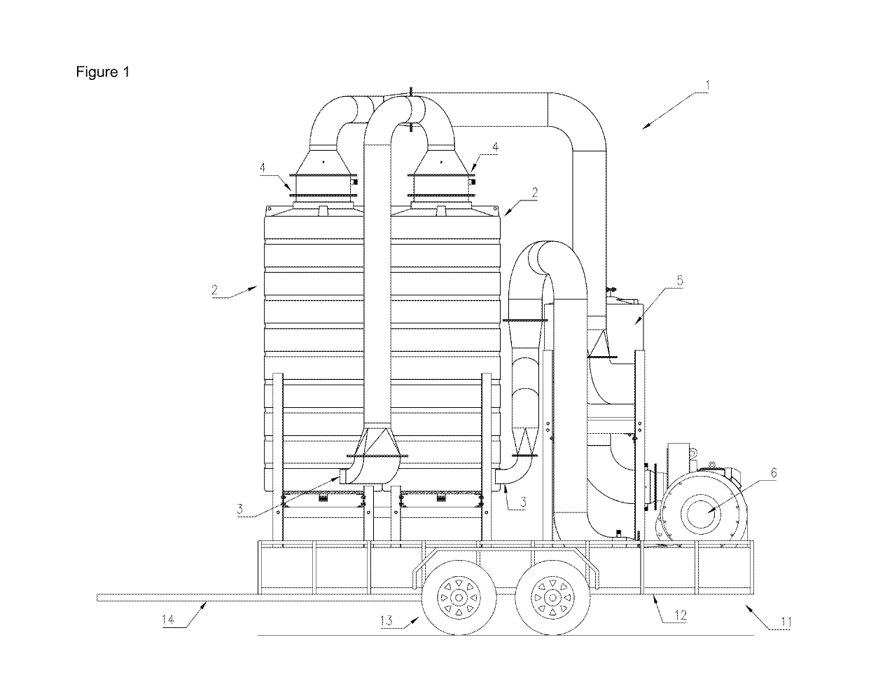

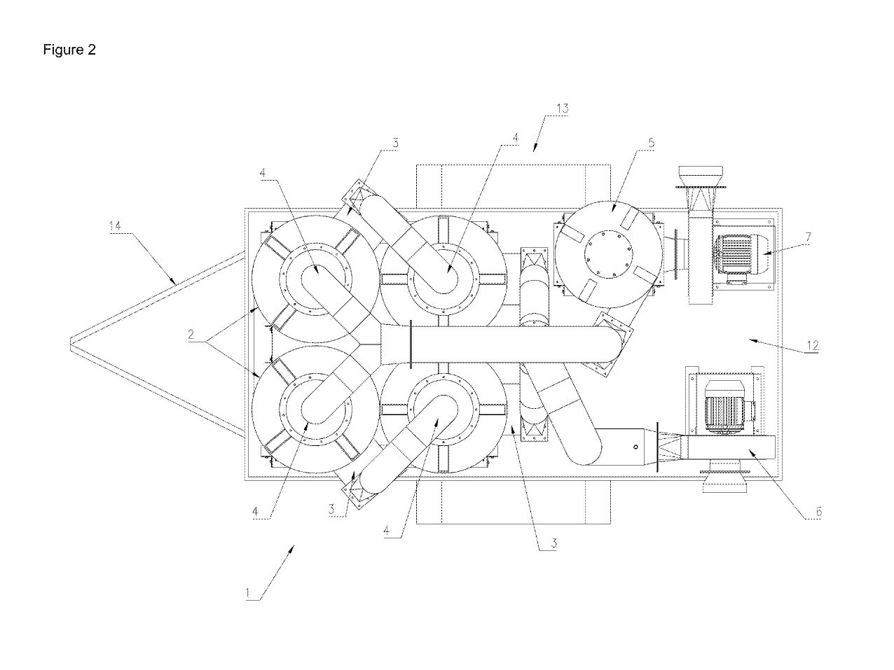

FIGS. 1 and 2 show side and plan views of a gas capture and treatment apparatus 1 as provided in accordance with a preferred embodiment. FIG. 3 provides a side cross section view of one of the channels 2 used in the construction of the apparatus.

The capture apparatus 1 includes an array of four channels 2 which can be connected to a volume containing a fumigant gas. In the embodiment shown the apparatus 1 is arranged to receive methyl bromide gas extracted from a pile of covered logs after the completion of a fumigation process. In various embodiments methyl bromide gas extracted from the log pile may pass through a heat treatment structure (not shown) before reaching the channels 2. This heat treatment structure can be used to raise the temperature of the methyl bromide gas prior to delivery to a channel.

Each channel 2 defines an inlet 3 which receives gas and an outlet 4 which allows gas to exit the channel. As can be seen from FIGS. 1 and 2 the channels have a vertical orientation with the outlet 4 at the top of the channel and the inlet 3 at the bottom of the channel.

FIG. 2 shows how each of these four channels can be configured in a modular fashion to vary the treatment applied to the gas supplied to the apparatus. In the particular embodiment shown the four channels are split into two pairs of channels. The outlet of a first channel 2a is connected to the inlet of a second channel 2b. The outlet of the second channel is then connected to a centrifugal filter 5 which removes entrained treatment liquid and allows the treated gas flow to be vented to atmosphere.

In other configurations all four channels may be connected outlet to inlet to maximise the treatment applied to a gas flow, and can potentially have the outlet of the final channel connected to the inlet of the first channel to recirculate the gas flow.

The capture apparatus 1 includes a pair of drive structures, formed in this embodiment by an inlet fan 6 and outlet fan 7. These fans are arranged to drive fumigant gas through each of the channels by either a blowing or suction effect.

As shown with respect to FIG. 3 the apparatus 1 includes a reservoir of treatment liquid 8 which is provided to deliver treatment liquid to a spray nozzle 9 integrated into each channel. In the embodiment shown this treatment liquid is formed from an organic solvent, although other compounds such as basic or alkaline liquids can be used in alternative embodiments.

Each spray nozzle 9 is adapted to deliver a treatment liquid into the channel 2 and is provided adjacent to the outlet 4 of the channel.

Each channel also contains a large number of packing elements positioned within the channel to allow the spray nozzle 9 to spray treatment liquid on to the packing elements. In the embodiment shown these packing elements are formed by a collection of tellerettes 10.

In use treatment fluid is delivered from the reservoir to each spray nozzle 8 and sprayed on to the tellerettes 10 packed into the interior of each vertically orientated channel 2. Fumigant gas is then driven through the channels under the action of either or both of the inlet and outlet fans 6, 7. The action of the fans drives the fumigant gas into contact with both a mist of treatment liquid droplets in addition to the treatment liquid coating the surfaces of the packing element tellerettes 10.

This used of vertically orientated channels filled with packing elements maximised the contact surface area and interaction between the treatment liquid and the gas flow, promoting a phase change to liquid for the fumigant gas. The treatment liquid then reacts with the captured fumigation compounds to neutralise same into a more benign form. Treated gas flows can then be vented to atmosphere without the fumigant compounds they once captured, and the treatment fluid used to neutralise these compounds can simply be drained from each channel and pumped back to the reservoir 8.

As can be seen from FIGS. 1 and 2 the apparatus also includes a mobile support platform 11. This platform is used to mount and support the various additional components of the invention through the provision of a deck 12 mounted to a set of wheels 13. A towing linkage 14 is also provided at one end of the deck to allow the apparatus to be towed by a vehicle from site to site.

In these embodiments the vertical height of each of the invention's channels may be restricted or controlled to provide a compact and manoeuvrable mobile apparatus 1. The interconnected channels mounted on the mobile platform can provide all the processing capacity required by a range of applications without necessarily increasing the height of the apparatus to where it would be prevented from accessing confined locations.

These channels can also be interconnected with one another in a modular fashion to suit the requirements of a particular application or fumigation space. When combined with the mobile platform this staged or modular arrangement provides for a portable character, allowing the operative components of the invention to be towed to various locations through or into restricted spaces.

In the preceding description and the following claims the word “comprise” or equivalent variations thereof is used in an inclusive sense to specify the presence of the stated feature or features. This term does not preclude the presence or addition of further features in various embodiments.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

1.-22. (canceled)

23. A fumigant gas capture apparatus which includes
at least one channel with a vertical orientation adapted for connection to a volume containing a fumigant gas, the channel defining an inlet located at the bottom of the channel which receives gas and an outlet located at the top of the channel which allows gas to exit the channel,
at least one drive structure arranged to drive fumigant gas through the channel,
at least one spray nozzle adapted to deliver a treatment liquid into the channel, and
at least one packing element positioned within the channel to allow a spray nozzle or nozzle to spray treatment liquid on to the packing element.

24. The fumigant gas capture apparatus as claimed in claim 23 wherein said at least one packing element is sprayed with treatment liquid by a spray nozzle to coat at least a portion of the surface of said at least one packing element with treatment liquid to expose fumigant gases to the coated surface or surfaces of the packing element when driven through the channel.

25. The fumigant gas capture apparatus as claimed in claim 23 which captures and treats methyl bromide.

26. The fumigant gas capture apparatus as claimed in claim 23 which includes a reservoir of treatment liquid adapted to deliver treatment liquid to said at least one spray nozzle.

27. The fumigant gas capture apparatus as claimed in claim 26 wherein the treatment liquid is a basic or alkaline liquid having a pH value of at least seven.

28. The fumigant gas capture apparatus as claimed in claim 26 wherein the treatment liquid is composed from or includes an organic solvent.

29. The fumigant gas capture apparatus as claimed in claim 23 wherein a channel is formed by a linear conduit with a single inlet at one end and a single outlet at its opposite end.

30. The fumigant gas capture apparatus as claimed in claim 29 which incorporates a plurality of channels arranged for interconnection with one another with linkages being provided between the outlet of one or more channels to the inlet of one or more further channels.

31. The fumigant gas capture apparatus as claimed in claim 30 wherein fumigant gas flows are filtered through a plurality of sequentially arrayed channels.

32. The fumigant gas capture apparatus as claimed in claim 23 which integrates one spray nozzle only in each of its channels, each spray nozzle being positioned adjacent to the outlet of the channel.

33. The fumigant gas capture apparatus as claimed in claim 23 wherein a packing element reduces the size of treatment liquid droplets sprayed on the packing element on which the fumigant gases are exposed to when driven through the channel.

34. The fumigant gas capture apparatus as claimed in claim 23 wherein a packing element promotes a phase of the fumigant gas compounds into a liquid form.

35. The fumigant gas capture apparatus as claimed in claim 23 wherein a packing element is formed from a tellerette arranged to induce turbulence in the fumigant gases and optimise the surface area contact between the gases and liquids within a channel.

36. The fumigant gas capture apparatus as claimed in claim 23 wherein a channel employed with the invention locates a plurality of packing elements.

37. The fumigant gas capture apparatus as claimed in claim 23 wherein packing elements form a packed tower arrangement when a channel has a substantially vertical orientation with treatment liquid sprayed into the top of the tower and fumigant gases driven through the bottom of the tower.

38. The fumigant gas capture apparatus as claimed in claim 23 which employ one or more of fans or pumps to push and or pull gas flows through conduits.

39. The fumigant gas capture apparatus as claimed in claim 23 wherein a fan or pump is provided for each channel.

40. The fumigant gas capture apparatus as claimed in claim 23 which includes a heat transfer structure engaged with the inlet of at least one channel.

41. The fumigant gas capture apparatus as claimed in claim 23 which includes a mobile support platform supported by set of wheels.

42. A method of fumigant gas capture characterised by the steps of:
spraying a treatment liquid into a channel to intersect with at least one packing element, and
driving a fumigant gas through the channel and into contact with the sprayed treatment liquid.
